(19) United States
(12) Patent Application Publication
(10) Pub. No.: US 2015/0256817 A1
(43) Pub. Date: Sep. 10, 2015

(54) Imaging Adapter and Method of recording and playback

(71) Applicant: Albert John Hofeldt, Miami Beach, FL (US)

(72) Inventor: Albert John Hofeldt, Miami Beach, FL (US)

(21) Appl. No.: 14/705,001

(22) Filed: May 6, 2015

Related U.S. Application Data
(60) Provisional application No. 61/997,221, filed on May 27, 2014.

(51) Int. Cl. H04N 13/02; H04N 5/225; G02B 21/36; H04N 13/00

(52) U.S. Cl. CPC H04N 13/0296; H04N 13/0055; H04N 13/0239; H04N 5/2254; G02B 21/367; G02B 21/362

(57) ABSTRACT

My invention provides an adaptor housing two cameras for stereoscopic real-time digital viewing and image capture of (1) the immediate environment viewed by the observer, (2) the images viewed through the optical system of a microscope to which my invention is attached, and (3) the images illuminated by an attached slit beam light and viewed by the observer through parfocal right and left compound microscopes or magnifying lenses affixed to my adaptor. By viewing the binocular digital displays the observer is seeing in real-time the focused target and has the option to photograph anything of interest by a right or left digital imaging device or both at any time. Simultaneously image capture of viewable field with both imaging devices produce stereoscopic image format. Importantly, the captured images are an exactly copy of the observer's view because he is observing the images on the digital displays, in real-time, in focus and in the observed lighting parameters. For playback, image files are transferred unaltered to a digital display or incorporated into a presentation program for synchronous video 3D viewing. My invention may also serve as a stereo viewer by mounting a playback display horizontally in the stereo-dividing insert.

My invention provides for (1) housing dual smartphones or cameras and (2) facility for optical focusing attachments and lighting for observing and capturing mono or stereo photographs while real-time viewing the stereo digital images and means for playing back captured image files.

My first embodiment provides simultaneous stereo images capture in either still or video format using two smartphones or two cameras of the environment being viewed by the observer without facility of additional focusing or lighting attachments. Synchronized playback of captured right and left image pairs can be viewed on the screens of the recording devices housed in my adaptor. Alternatively, the stereo-paired images may be transferred to a presentation program as a synchronous pairs for playback on a single screen viewable through a stereo-viewer.

The second embodiment of my adaptor provides observation and photographic capture via a binocular instrument, such as, a slit lamp microscope, operating microscope, or other binocular instruments. Currently a photographic camera or other imaging device for capturing images viewed through the optical system of a slit lamp, microscope, or operating microscope is attached to one ocular of the device. The attached recording device either images the viewable image directly or through a beam splitter that shares the rays with an observer. When the imaging camera is mounted onto one eyepiece, the examiner can no long view stereoscopically. Often times the captured images are not satisfactory because the focusing status and lighting parameter may vary from what the observer is imaging since the camera is not incorporated in the examiner's real-time viewing line-of-sight.

The third embodiment of my adaptor incorporates two imaging devices with (1) a compound miniature microscope or magnifying lens to each of the camera ports of my adaptor and (2) a slit light source for illumination. This embodiment provides means of capturing macro stereo images in fine detail of structures such as the human eye by the cameras of the two attached imaging devices while positioning a slit light to accent key features of the image. Such an embodiment is mounted on a headband worn by the observer and as thus serves as a hands-free portable slit lamp.

### DETAILED DESCRIPTION OF INVENTION

In FIG. 1 is the front view of embodiment 1 showing baseplate 5 having recesses 14 and 15 for holding two smartphones or cameras, such as, iPhone 7 and iPhone 8 as seen in FIG. 2. The elements of baseplate 5 of embodiment 1 as shown in FIG. 1 are camera viewing ports 15 and 16 providing openings for passage of image rays, recesses 14 and 15 for housing iPhones 7 and 8, magnets 17a-17d and fastening screws 18a-18d to secure magnets 17a-17b, and holes 19a-19d for attaching brackets supporting lens couplers 33 and 34 seen in FIG. 2. Shown in FIG. 2 is embodiment 1 with iPhones 7 and 8 attached, lens couplers 33 and 34 that support lenses 9 and 10, sliding bars 11 and 12 which adjust the horizontal position of lenses 9 and 10 without rotating. Vertical adjustments of lens 10 is made by sliding lens coupler 33 up or down on brace rod 3 which is preferably hexangular. A hexangular shape provides for easy repositioning to the prior position and as will be expanded upon in the specifications of FIG. 5. Only one lens needs to move vertically to provide relative vertical alignment for binocular image fusion. Coupler 33 is supported by brace rod 77 having treads along the lower part so that treaded rotatory knob 79 a when rotated moves coupler 33 up or down along rod 3. Spring 78 fits around rod 77 and exerts tension on coupler 33 so that rotating knob 79 remains in contact with coupler 33 when coupler 33 is moved downward. Magnets 17a-17d holds iPhones 7 and 8 securely and provide for quick and easy removable. Should a camera not be sufficiently attracted by the magnets, adhesive magnetic material can be affixed to the back of the camera to improve magnet attraction. Means other than magnets may be used to hold a camera in position, such as, clips or walls along the edge. Switch base 51 with push-button momentary switch 52 connects to the audio ports of iPhones 7 and 8 by cords 50a and 50b. By depressing push-button 52, both iPhones simultaneously capture images and thereby synchronize exposure. Illustrated in FIG. 3 is the backside of baseplate 5 showing camera viewing-ports 15 and 16, handgrips 21 and 22, and bolts 23, 24, 25 and 26 that secure the brackets for couplers 33 and 34 to baseplate 5. Cross-section 4 is seen in FIG. 4 showing camera port 15 in baseplate 5 and iPhone 8. In FIG. 5 is a side view of embodiment 1 showing coupler 33. In this illustration, coupler 33 and brackets coupler support bars 26 and 27 are constructed of clear acrylic plastic to reveal internal details. Setscrews 130 and 131 in brackets 26 and 27 secure hexangular rod 77 from moving vertically and rotationally. Within coupler 33 are springs 120 and 121, magnets 122 and 123, rectangular lens bar 12, and rod 77. Wall 124 forms the proximal surface of coupler 33 and is secured by knurled nut 125 and screw 126. Wall 124 is in apposition with lens bar 12. Bar 12 is of such a horizontal size that more than fills the space it occupies so that when knurled nut 125 is fully tightened, wall 124 compresses against bar 12 to create sufficient friction to immobilize bar 12. As a result of immobilizing bar 12 the horizontal position of lens 10 becomes fixed. Spring 120 exerts tension of magnet 122 and both spring 120 and magnet 122 inhibit rotation around hexangular steel rod 77 from rotating. Spring 121 and magnet 123 also inhibit rotation around rod 77. The flat surface of magnets 122 and 123 rest against the flat surface of the hexangular rod 77 in 6 positions. Magnets 122 and 123 will stop rotation of coupler 33 and maintain that position at each of the 6 flat surfaces on hexangular bar 77 until the torsional force exceeds the friction produced by magnets 122 and 123 and springs 120 and 121. The hexangular rod 77 is locked in position by setscrew 130 and 131 so that the flat surface of one of the 6 positions of hexangular rod 77 is parallel with bar 12 and with the surface of the screen of iPhone 8. By positioning bar 12 parallel with the screen of iPhone 8, viewing lens 10 is parallel with the screen of iPhone 8. Setscrew 133 sets the position of the hexangular bar on that side to align lens 9 (FIG. 6) parallel with the screen of iPhone 7. In addition spring 121 exerts tension of lens bar 12, which provides resistance to movement of bar 12 prior to immobilizing bar 12 by tightening knurled nut 125. Handgrip 21 provides means for grasping embodiment 1.

In FIGS. 6-11 is embodiment 2 of my invention viewed from the top. This embodiment attaches to a slit lamp bio-microscope or other binocular microscopes by way of oculars 87a and 87b and the housings of oculars 87a and 87b. In FIG. 1 is illustrated housing 93 of ocular 87a. Baseplate 41 and 42 have countersink 85 (FIG. 7), a recess just large enough to fit around the circumference of ocular 87a and 87b where baseplate 41 makes contact with ocular 87a and baseplate 42 makes contact with ocular 87b. This recess provides an anchor for the adaptor to align with the microscope. Brackets 81 and 82 attach to baseplates 41 and 42 by braces 84a-84d, which are secured by nuts 88a-88d. Similarly, clamps 140 and 143 are secured by finger bolts 141a-141d. Brackets 81 and 82 fit against the inferior of the housings of ocular 87a and 87b while clamps 140 and 143 fit against the superior of oculars 87a and 87b, an arrangement that provides rigid support using counter-force. Embodiment 2 is held firmly in place by both upward support by bracket 81 and 82 and downward support by clamps 140 and 143. Since bracket 81 and 82 are slotted, the adaptor can be quickly and easily positioned and removed from the microscope by sliding. Once aligned, clamps 140 and 143 are placed over ocular 87a and 87b and secured by finger bolts 141a-141d.

Since microscope oculars converge to provide optical alignment, baseplates 40 and 41 are connected by one or more hinge 62, which allows the necessary movement for the oculars to align with ocular housings of the microscope 91. Depending upon the specific microscope, spacer 89 may need to be positioned beneath hinge 62 on the side of either baseplate 41 or 40 to allows both oculars 87a and 87b to slide completely into the microscope housing.

As seen in FIGS. 8 and 9, iPhone 8 is mounted horizontally within embodiment 1 or 2 for the purpose of also utilizing the adaptor as a stereo-viewer. For example stereo image pairs can be presented side-by-side in a Keynote or PowerPoint program and viewed stereoscopically. Insert 150 is rectangular and fits into notch 155 of each bracket rod of couplers 33 and 34, such as rods 26 and 28 illustrated in FIG. 9. Insert 150 may support iPhone 8 or other digital display device by housing magnets or by retainer wall 152. For stereo viewing, the subjects views through lenses 9 and 10 and stereo-divider 151 isolates the view of each eye. A linear opening is stereo-viewer 151 allows stereo-divider to slide over iPhone 8 and under insert 150 to maintain vertical and horizontal stability of stereo-divider 151.

In FIG. 10 are examiner 90 and subject 91 facing each other with slit lamp bio-microscope 92 between them. Examiner 90 is viewing the screens of iPhones 7 and 8 housed in embodiment 2, which attaches to microscope by brackets 81 and 82 and clamps 140 and 143. Subject 91 is looking straight ahead with his forehead pressed against headrest 95. Slit light 98 illuminates the eye of subject 91. In FIG. 11 is a frontal view of embodiment 2 attached to slit lamp microscope 92.

Embodiment 3 is seen in FIGS. 12-15, which is my adaptor connecting iPhones 7 and 8 with slit light 160, microscope 100 and 102, and headband 105 to provide a portable slit lamp microscope. Headband 105 attaches to baseplate 5 by bracket 104. Flexible bands 107 traverse the head and attaches to band 105 while knob 106 tightens and loosens band 105. Spectacles 141 support lenses 140 which provide clear focus of the displays of iPhone 7 and 8 or other digital display devices. Battery 150 connects by cable 151 to slit light 160. Slit light 160 slides on curved bar 161, which is attached to baseplate 5 by brackets 162 and 163 (FIG. 13). Rotatable rod 164 with sprockets 165 and 166 that travel in a curved path in the cogs of brackets 167 and 168 having the same shaped path as curved bar 161 supporting slit light 160. By rotating knob 170, rod 164 rotates and causes sprockets 165 and 166 to mesh with cogs of brackets 167 and 168, which in turn moves slit light 160 alone curved rod 161 in small increments. The radius of curved rod 161 is such that at any point along the path of rod 161, the beam of slit light 160 is parfocal with the focal points of microscopes 101 and 103 as seen by ray tracings 200, 201, and 202 in FIG. 14. Microscopes 100 and 102 may be magnifying lenses or compound microscopes, which are parfocal with each other and with the beam of slit light 160. Optical conduits 101 and 103 contain prisms or mirrors to deviate the light rays transmitted from microscopes 100 and 102 to the cameras of iPhones 7 and 8 to the extent to make microscopes 100 and 102 parfocal at a desired working distance. Cushions 110 and 111 supported by adjustable braces 112 and 113 provide means to rest embodiment 3 against the face of a subject to steady the examination at a suitable distance.

### Method for Video Recording and Playback

Stereoscopic video recordings require synchronous exposure and playback of paired image files. My method of recording is to simultaneously trigger iPhone 7 and iPhone 8 by triggering switch 52 having two connecting cables, one to the audio outlet iPhone 7 and the other to the audio outlet of iPhone 8. iPhones and other devices can be setup to capture a photograph by selecting the volume control to trigger exposure. Triggering momentary switch 52 closes an electrical circuit that simultaneously activates both imaging devices. Alternatively, iPhones 7 and 8 can be programmed to trigger by sound. Once the images are stored on iPhones 7 and 8 and B, the files are transferred electronically by AirDrop or other means to a presentation program, such as, Keynote Apple or PowerPoint Microsoft programs. A slide in the presentation program is created for each pair of stereo video files. The video file from the right camera is positioned on the right side of the slide and the video file from left camera is positioned on the left side of the slide. These paired video files begin playback synchronously by selecting “start upon opening” command for each of the video files. Images from the right and left iPhones are seen simultaneously when such as presentation is viewed in a stereo-viewer.

The process for displaying stereo images and playing back stereo video files is as follows:

1. Transfer recorded right and left image pairs to a presentation program slide in Keynote Apple program, PowerPoint Microsoft program, or another vender's program.
2. Arrange the right image of the image pair on the right half of the slide and the left image on the left side of the slide and align the image pair horizontally.
3. To synchronize two video files to start simultaneously, select in the movie menu “start on opening” for both paired video files.
4. Once the presentation file is created as 1-3 above the file is opened on a computer screen, iPod screen, iPhone screen, etc. and viewed while observing through an appropriate stereo-viewer.

### BRIEF DESCRIPTION OF FIGURES

FIG. 1 is a frontal view of the baseplate of embodiment 1 of my adaptor without smartphones mounted.

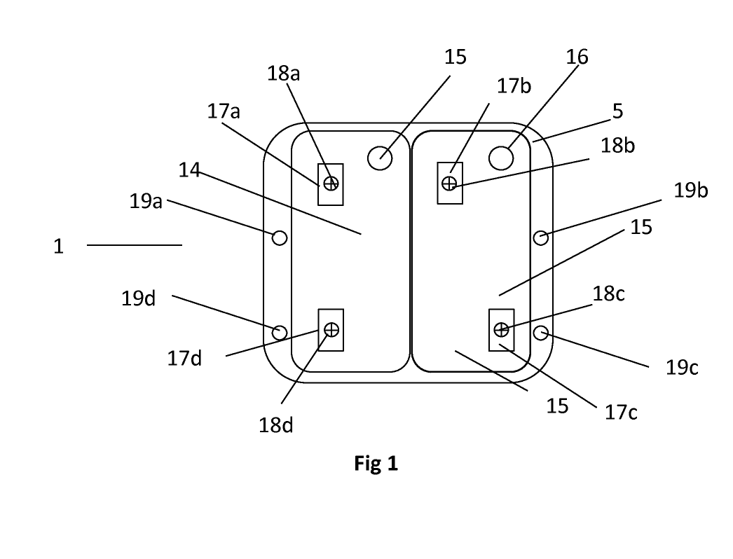

FIG. 2 is a frontal view of the baseplate of embodiment 1 of my adaptor with smartphones mounted.

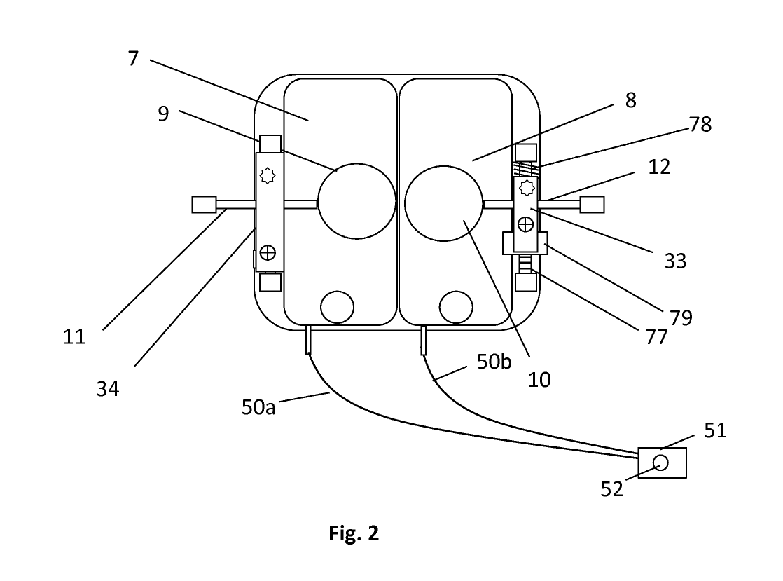

FIG. 3 is a view of the back of the baseplate of embodiment 1.

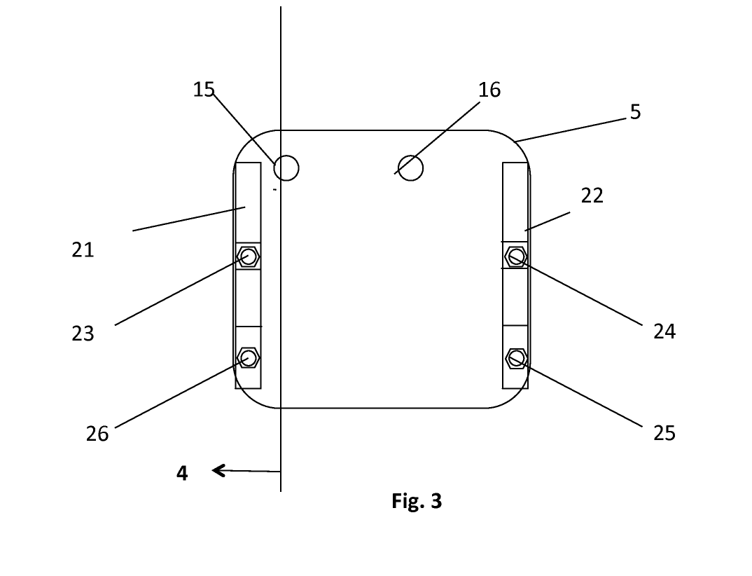

FIG. 4 is a cross-section view of baseplate of embodiment 1.

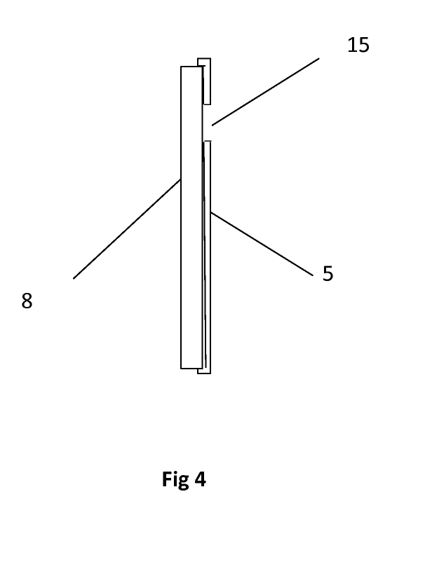

FIG. 5 is a side view of the baseplate of embodiment 1 of my adaptor detailing coupler 33.

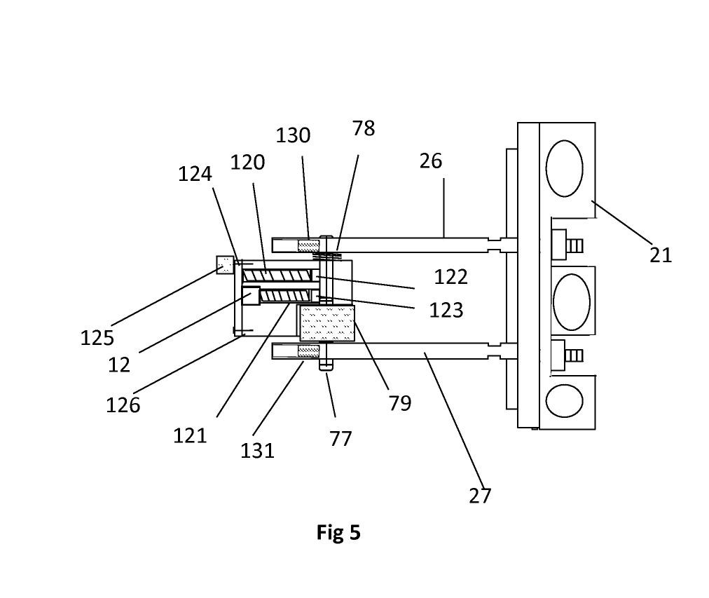

FIG. 6 is a top view of embodiment 2 with microscope oculars.

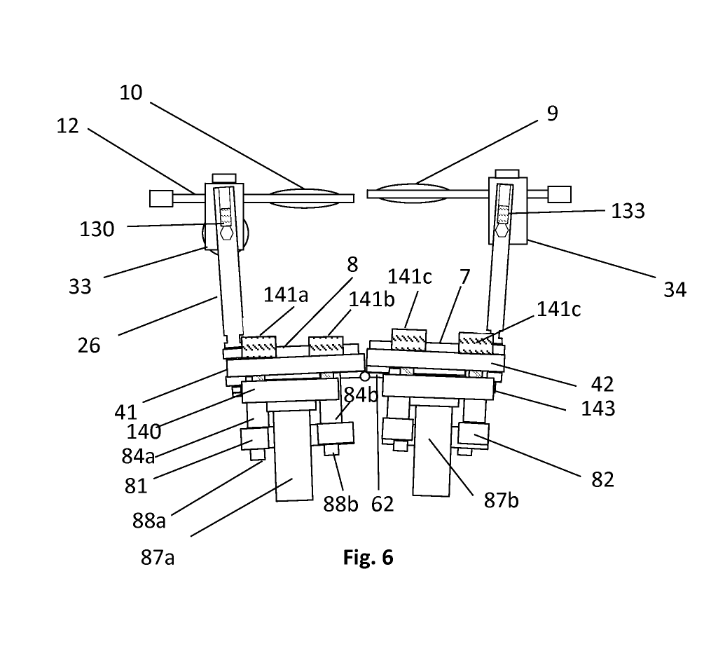

FIG. 7 is a back view of embodiment 2.

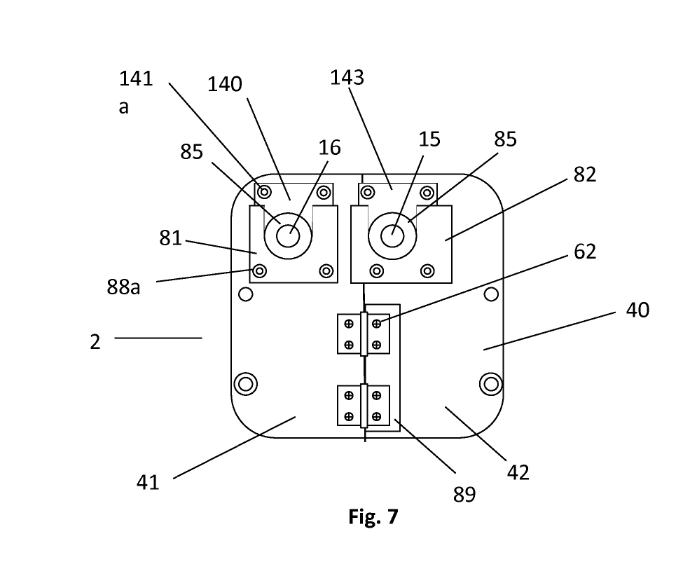

FIG. 8 is a frontal view of embodiment 1 or 2 with stereo-dividing insert mounted.

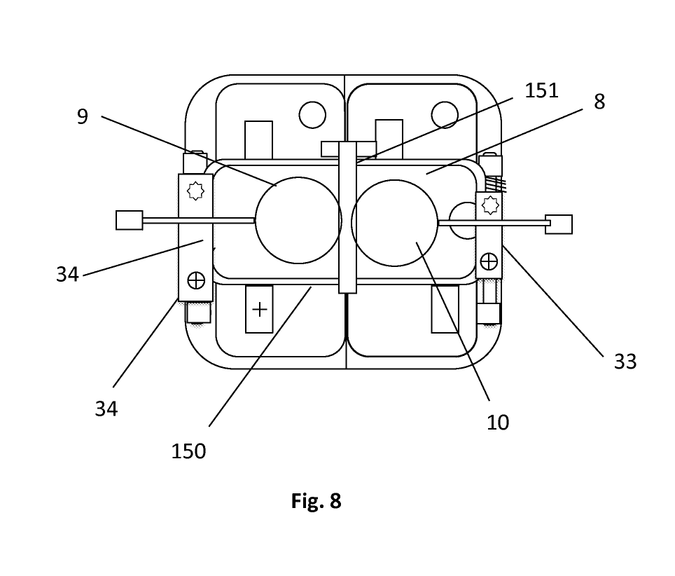

FIG. 9 is a top view of embodiment 2 with stereo-dividing insert mounted.

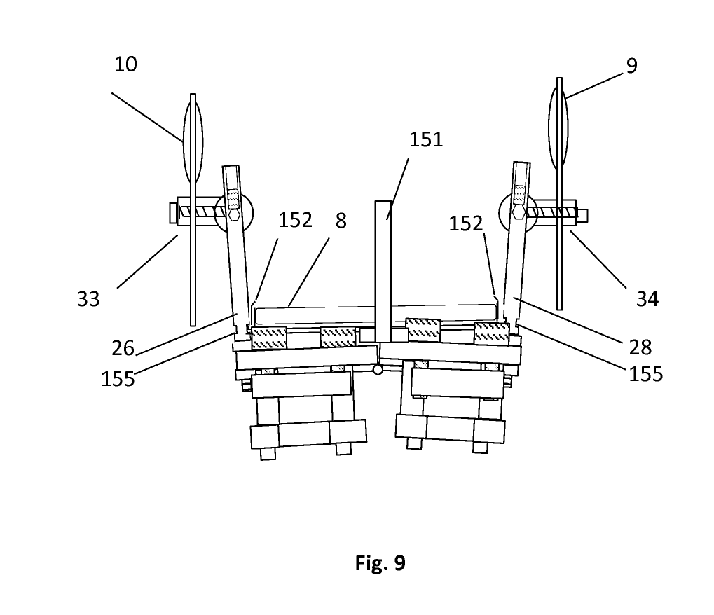

FIG. 10 depicts a slit lamp bio-microscopic examination with embodiment 2 attached.

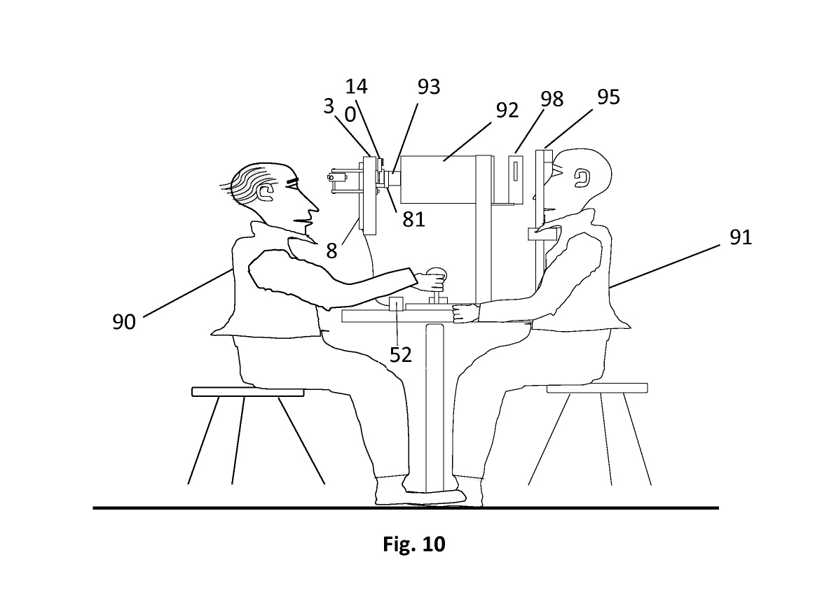

FIG. 11 is a frontal view of embodiment 2 attached to a slit lamp bio-microscope.

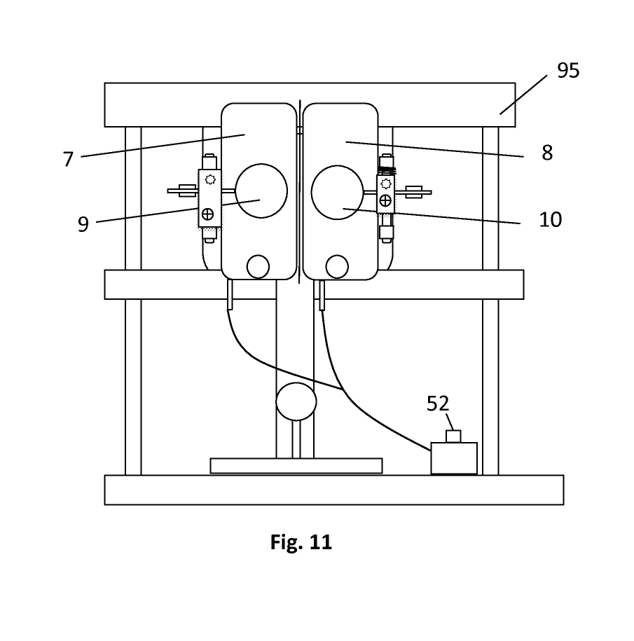

FIG. 12 is a side view of an examiner-wearing embodiment 3.

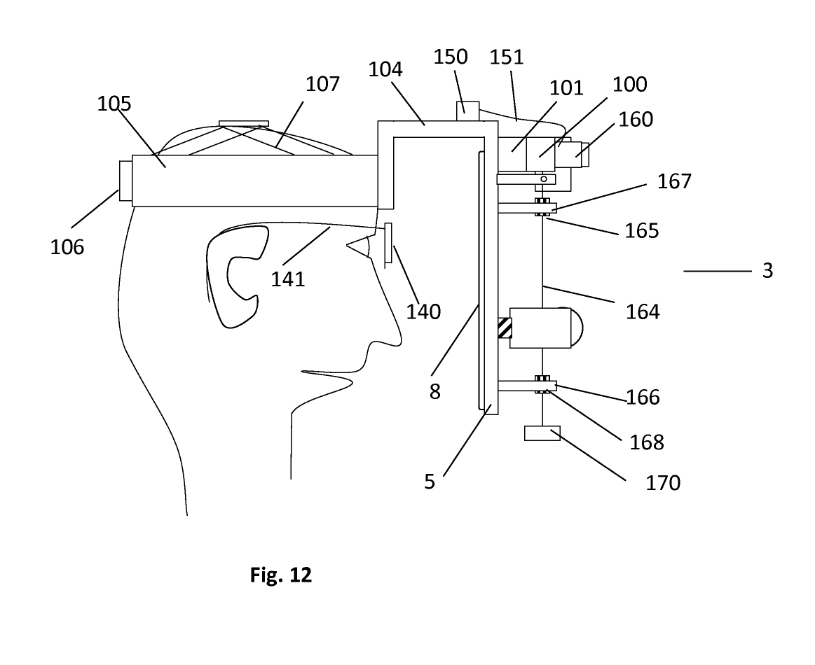

FIG. 13 is a top view of embodiment 3.

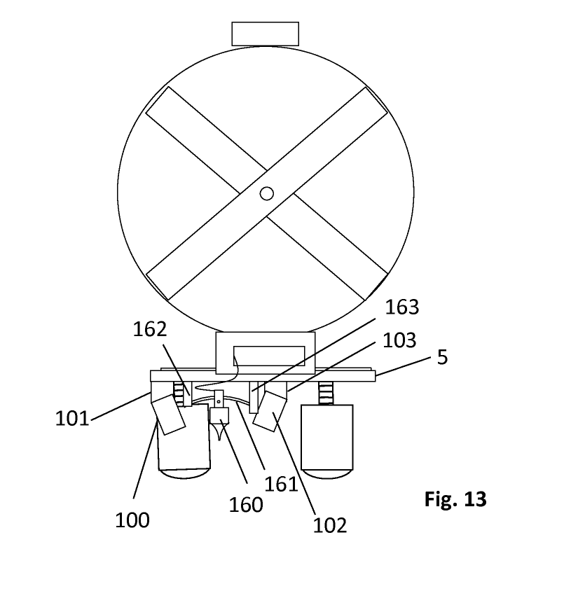

FIG. 14 is a top view of embodiment 3 showing ray tracings.

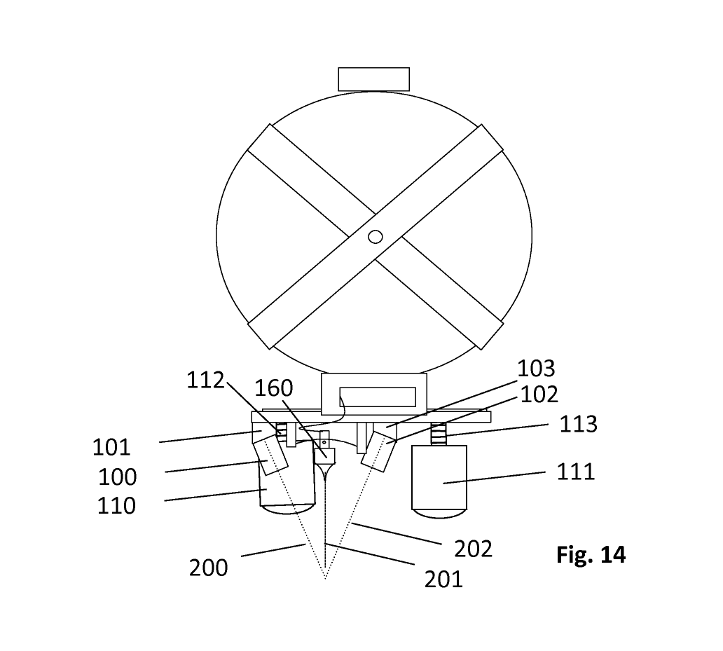

FIG. 15 is the rear view of embodiment 3.

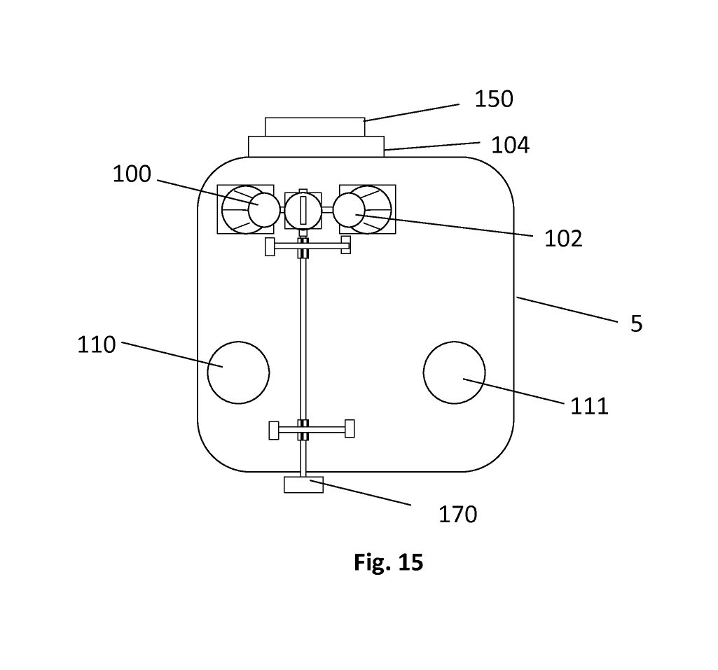

1. An device for adapting two smartphones or digital cameras for stereoscopic observation and photography consisting of:
a. a plate holding said smartphones positioned vertically and aligned side by side to each other such that the screens of said smartphones face the observer and the camera lenses are aligned with two perforations in said plate,
b. adjustable right and left optical lenses mounted to said plate such that said observer is in clear binocular focus of the said screens, and
c. means of activating simultaneous picture capture by said smartphones or cameras.

2. The device of claim 1 where the playback of recorded files are transferred to a presentation file, aligned for 3D viewing and programmed to start synchronously for viewing on a computer screen using a stereo-viewer.

3. The device of claim 1 where a stereo-dividing insert is secured within said device for holding a digital display in the horizontal position to allow a subject to view through said optical lenses for observing stereoscopic images playing back on the screen of said digital display.

4. An device for adapting two smartphones or digital cameras to a microscope, slit lamp microscope or other type binocular viewing system, for stereoscopic observation and photography consisting of:
a. two side-by-side plates connected by one or more hinges and with means of adjusting the angle between said plates where each plate holds one of said smartphones vertically and both of said smartphones are aligned so that the screens face the observer and the camera lenses face perforations in said plates which are aligned with the optics of said microscope,
b. optical lenses mounted to said plates such that said lenses are vertically and horizontally adjustable to provide an observer clear single binocular focus of the said screens and where said lenses are easily movable in and out of the line of sight to facilitate making touch commands on the screen,
c. clamps and possibly brackets for attaching said plates to said microscope so that said camera lenses are aligned with the optics of the said microscope, and
d. means of activating simultaneous picture capture by said smartphones or cameras.

5. The device of claim 3 where the playback of recorded files are transferred to a presentation file, aligned for 3D viewing and programmed to start synchronously for viewing on a computer screen using a stereo-viewer.

6. The device of claim 3 where a stereo-dividing insert is secured within said device for holding a digital display capable of playback in the horizontal position to allow a subject to view through said optical lenses image playback on the screen of said digital display.

7. A device for adapting two smartphones or digital cameras, two small microscopes or magnifiers, and a slit light for providing a portable slit lamp microscope for stereoscopic observation and photography consisting of:
a. a plate attached to a headband with said plate holding said smartphones positioned vertically and aligned side by side to each other such that the screens face the observer and the camera lenses face said microscopes,
b. adjustable optical lenses mounted to the spectacle frames on the observer to provide clear binocular focus of the said screens,
c. optical conduits containing prisms or mirrors attaching said plate to said microscopes so that said camera lenses are aligned with the optics of the said microscopes and where the focal length of said microscopes is less than 14 inches and said microscopes are angled so that the focal points converge to a point midway between said microscopes,
d. one or more brackets for mounting a slit light that aligns the beam of said slit lamp with the focal point of said microscopes at any position of said slit light along the path provided by said bracket and with means to change the angle said beam incidences said focal point of said microscopes,
f. means of activating simultaneous picture capture by said smartphones or cameras.

8. The device of claim 5 where the playback of recorded files are transferred to a presentation file, aligned for 3D viewing and programmed to start synchronously for viewing on a computer screen using a stereo-viewer.
